(19) United States
(12) Patent Application Publication
(10) Pub. No.: US 2006/0004823 A1
(43) Pub. Date: Jan. 5, 2006

(54) Method and system for assembling databases in multiple-party proceedings

(75) Inventor: Richard W. Simmons, Golden Valley, MN (US)

Correspondence Address: John C. Reich;MERCHANT & GOULD P.C., P.O. Box 2903, Minneapolis, MN, 55402-0903, US

(73) Assignee: Analytics Incorporated

(21) Appl. No.: 11/219,152

(22) Filed: Sep. 2, 2005

Related U.S. Application Data
(63) Continuation of application No. 09/772,199, filed on Jan. 29, 2001, now abandoned.
(60) Provisional application No. 60/179,696, filed on Jan. 28, 2000.

(51) Int. Cl. G06F 17/00

(52) U.S. Cl. 707/101

(57) ABSTRACT

Methods and systems for assembling databases in multiple-party proceedings. Class members or their agents can file claims online using a computer network connected to the database. The online connection may be provided as a web site accessible through the Internet. Users file claims by submitting Identifying Information and Claim Information, both of which may be validated in order to prevent fraudulent or otherwise invalid claims. Class members may be provided with reference strings prior to filing the claim. The users are prompted to submit the reference strings when filing the claims for purposes of administration and to verify the authenticity of the filing. The filed claims are stored in a database which may be accessible to parties in the class action.

### CLAIM TO PRIORITY UNDER 35 U.S.C. § 119(E)

Priority under 35 U.S.C. § 119(e) is claimed to provisional application Ser. No. 60/179,696, filed on 28 Jan. 2000, and entitled, “METHOD AND SYSTEM FOR ASSEMBLING DATABASES IN MULTIPLE-PARTY PROCEEDINGS.” The complete disclosure of application 60/179,696 is incorporated by reference herein.

### FIELD OF THE INVENTION

The present invention relates to methods and systems for assembling databases in multiple-party proceedings. In particular, the invention relates to methods and systems for assembling databases through a computer network.

### BACKGROUND OF THE INVENTION

The administration of a class action lawsuit is by nature a very cumbersome process. Class action status is typically granted when the group of parties (hereinafter called plaintiffs, which is the typical party subject to class status) is so large that it would be unduly burdensome for the courts to have each individual pursue a separate lawsuit. Therefore, a class action allows representatives for the class of plaintiffs to carry on the action against the defendant or defendants on behalf of all class members. Typically, all members of the class are deemed to be part of the lawsuit unless they explicitly withdraw (“opt out”). The class of plaintiffs is bound by any settlement or judgment in the class action.

The class of plaintiffs can be very large; examples range up to over ten million plaintiffs in a single lawsuit. Therefore, the administration of the lawsuit, including the distribution of relief or recovery from a settlement or a judgment, has traditionally been a very costly process. At this time, class action litigants typically mail or have mailed large volumes of forms in order to administer the class action.

The identity of all of the members of the class of plaintiffs need not be known at the beginning of the lawsuit. Typically, the complaint lists one or more plaintiffs by name, followed by “and others similarly situated,” to indicate that the plaintiffs intend to seek class action status for the lawsuit. If a class is certified by the court, the class of plaintiffs includes all individuals and entities included in the class definition. Thus, the size of the identified members of the class may expand over time as further plaintiffs are identified, for example by discovery proceedings in the class action. The class definition also may be revised by the court.

Upon certification of the class by the court, the defendant will generate as complete a list of plaintiffs in the action as practicable. Potential class members are contacted to inform them of the existence of the class action lawsuit; to inform them of their rights; to provide them with the opportunity to “opt out” of the litigation; and to provide them with the ability to file a claim, if necessary. This is typically done by mailing a large number of Class Notices and/or Proof of Claim Forms, one to each known class member. Since the name and/or address of every class member is not always known, the mailed notice often does not reach every. plaintiff in the class action. The mailed notice typically is supplemented with a summary notice, where it is required that the summary notice of the class action be advertised in a suitable media such as a newspaper.

After receiving the Class Notice or Proof of Claim Form in the mail, only a percentage of the plaintiffs respond either by filing a claim or “opting out.” For example, in some class actions it is expected that about 10-15% of the plaintiffs will actually file claims. However, the transaction costs associated with processing the tens of thousands of claims or more that are received in the mail are significant. These transaction costs frequently are paid from the settlement fund, which significantly decreases the amount that each claimant could recover. Therefore, the total distribution in the class action lawsuit is diminished by the administrative costs associated with this mailing procedure, the costs of other attempts of notifying the plaintiffs, and the costs of the claims processing. Possibly, some plaintiffs may conclude that the sum of money they could receive does not outweigh the inconvenience of filling out a form, mailing it to the administrator and waiting for the results, and thus do not recover as intended by the settlement.

Class action litigation, although overcoming some problems associated with a large group of plaintiffs, gives rise to significant practical difficulties in communicating with a large group of persons. The expenses associated with overcoming these problems decrease the recovery that can be distributed to each plaintiff. Furthermore, unclaimed funds frequently are returned to the defendants or otherwise fail to benefit the class of plaintiffs. Some concerns have arisen that class action lawsuits provide attorneys with substantial fees for settlements that are fully received, but comparatively small reimbursements for the individual plaintiffs that may not be fully received.

Current systems generally fail to communicate with large numbers of participants in multiple-party proceedings with less administration and expense.

### SUMMARY OF THE INVENTION

One aspect of the invention relates to a method for assembling a database regarding claimant eligibility for relief in a multiple-party proceeding. The method comprises providing access via a computer network for filing one or more claims for relief in the multiple-party proceeding. In this aspect, each of the claims for relief comprise first information regarding a potential claimant and second information regarding the potential claimant's eligibility for relief. The method further comprises receiving each of the claims for relief via the computer network. Moreover, the method includes validating each of the claims for relief by comparing either of the first or second information against a predefined dataset. Further to this aspect, the pre-defined dataset can include a class list of known class members potentially eligible for relief.

In another aspect, the invention relates to a computer system for assembling a database regarding claimant eligibility for relief in a multiple-party proceeding. In particular, the system can comprise a client computing system for providing access via a computer network for filing one or more claims for relief in the multiple-party proceeding. In this aspect, each of the claims for relief can comprise first information regarding a potential claimant and second information regarding the potential claimant's eligibility for relief. Additionally, the system can comprise a server computing system for receiving each of the claims for relief via the computer network. Still further in this aspect, the system can include a validation module for validating each of the claims for relief by comparing either of the first or second information against a pre-defined dataset.

### BRIEF DESCRIPTION OF THE DRAWINGS

The invention may be more completely understood in consideration of the following detailed description of various embodiments of the invention in connection with the accompanying drawings, in which:

FIG. 1 is a high-level diagram illustrating a computing environment for assembling a database regarding claimant eligibility for relief in a multiple-party proceeding;

FIG. 2 is a schematic illustration of the various the system of FIG. 1;

FIG. 3 is a high-level flow chart illustrating the logical operations of the system and method for assembling a database regarding claimant eligibility for relief in a multiple-party proceeding; and

FIGS. 4A-4B are more detailed flow charts illustrating the logical operations of the system and method for assembling a database regarding claimant eligibility for relief in a multiple-party proceeding.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present computing system will be described in detail with reference to the drawings, wherein like reference numerals represent like parts and assemblies throughout the several views. Reference to various embodiments does not limit the scope of the computing system, which is limited only by the scope of the claims attached hereto.

The following discussion is intended to provide a brief, general description of a suitable computing environment for implementing the computing system of the present disclosure. It should be recognized that the computing system of the present disclosure may be practiced with many computer system configurations and platforms, such as hand-held computers or devices, laptop computers, desktop computers, or network personal computers. The term “hand-held computer” is used broadly to refer to hand-held computing platforms, palm-held computing platforms, mobile computing systems, such as those typically installed in automobiles, or any other computing platforms that a user can easily transport or carry. One skilled in the art will readily recognize that the claimed invention also can be implemented in other types of computing platforms as well.

The embodiments of the present computing system are implemented as logical operations in a distributed processing system having client and server computing systems. The logical operations of the present computing system are implemented: (1) as a sequence of computer implemented steps running on the computing system; and (2) as interconnected machine modules within the computing system. The implementation is a matter of choice dependant on the performance requirements of the computing system implementing the various embodiments of the invention and the components selected by or utilized by the users of the system. Accordingly, the logical operations making up the embodiments of the computing system described herein are referred to variously as operations, steps, or modules.

As will become apparent from the discussion below in-connection with the accompanying drawings, the present disclosure has particularized applicability to class action lawsuits involving more than one class member asserting a claim for relief against one or more respondents. However, it will be appreciated by those having skill in the art that the present disclosure is not limited to the specific embodiments discussed below. Rather, the present disclosure has general applicability to any multiple-party proceeding involving more than one claimant asserting a claim for relief against one or more respondents, such as, a bankruptcy proceeding, a probate or estate dissolution proceeding, or any other similar multiple-party proceeding. Furthermore, it should be understood that the term claimant as used herein is generally applicable to individuals, corporations, and/or other entities who have either previously been identified as being eligible for inclusion in the multiple-party proceeding or those individuals seeking to establish their eligibility for inclusion in the multiple-party proceeding.

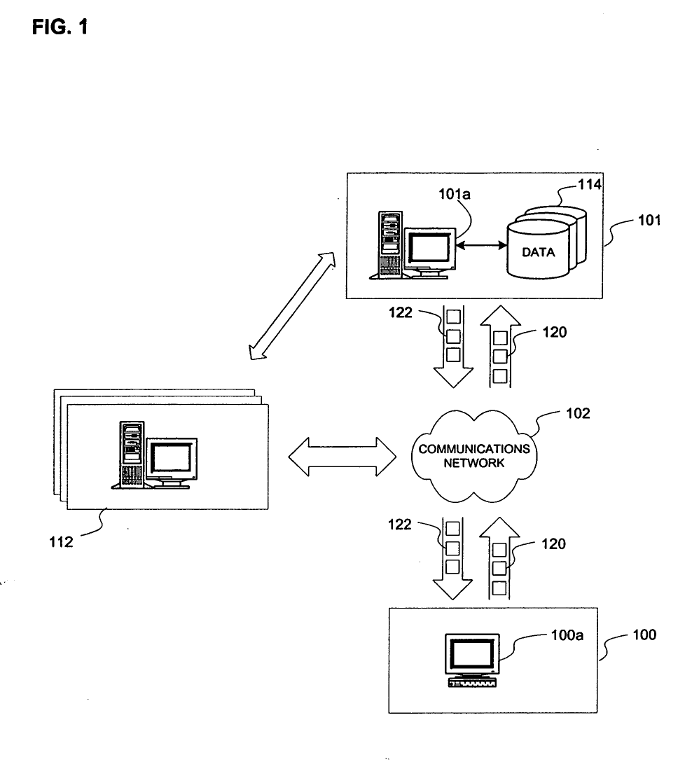

FIG. 1 illustrates a computing environment for implementing a system and method for assembling a database regarding claimant eligibility for relief in a multiple-party proceeding in accordance with the principles of the present disclosure. In the embodiment illustrated in FIG. 1, the computing environment comprises a client computing platform 100 that is capable of communicating with a server computing environment 101. The client computing platform 100 can include a client computing system 100a that is capable receiving one or more claims for relief 120 provided by each of the claimants accessing the system. Each of the claims for relief 120 provided by the claimants accessing the system can include claimant identifying information and/or claim processing information. The claimant identifying information generally refers to information that can be used to uniquely identify the claimant, such as, the claimant's name, address, social security number, or other similar identifying information. The claim processing information generally refers to information that can be used to establish the claimant's status within the proceeding, such as, eligibility, standing, claim value, or other similar information. For example, in a products liability class action lawsuit, the claim processing information can include purchase date, purchase location, product model number, product serial number, or other similar information that can be used during processing of the claim for relief. The claims for relief 120 provided by each of the claimants accessing the system will be discussed in greater detail below.

The server computing environment 101 can include a server computing system 101a that is configured to assemble and/or manage one or more databases 114 relevant to the multiple-party proceeding. In particular, the server computing system 101a is capable of communicating with the client computing platform 100a and distributing administrative information 122 to and/or receiving one or more claims for relief 120 from each of the claimants accessing the server computing system 101a as discussed above. The administrative information 122 generally refers to procedural or management information about the multiple-party proceeding, such as, notification of the existence of the proceeding, minimum criteria for eligibility, and other similar administrative information.

The client computing system 100a can be any computing system suitable for communicating with and receiving information from the server computing environment 101. For example, the client computing system 100a can be a laptop personal computer, a desktop personal computer, a hand-held computing device, such as, a Windows CE™ brand operating system device, any Tablet PC™ brand device, or any Palm™ operating system device, a wireless communications device, such as, a web-enabled cellular telephone, or any other similar device. Similarly, the server computing system 101a can be a general purpose and programmable computing system, such as an IBM-compatible personal computer. Preferably, the server computing system 101a is capable of performing tasks commonly handled by server computers, such as file and/or application management, network resource management, and other related services or tasks. The server computing system 101a typically has a resident operating system, such as those sold under the brand names Microsoft Windows™, Unix™, Linux™, DOS™, AIX™ or other similar operating systems.

The client computing platform 100 communicates with the server computing environment 101 via a communications network 102. In one embodiment, the communications network 102 is the Internet. In an alternative embodiment, however, the communications network 102 is an intranet, local area network, wide area network, or other similar communications network capable of allowing the more than one claimant to access the server computing environment 101 via the client computing platform 100. Moreover, a claimant can access the server computing environment 101 via the client computing platform 100 using a variety of connection types. For example, a claimant can access the server computing system 101a via a hard-wired connection, a direct-dial connection, a wireless connection (e.g., radio frequency or infrared), or other suitable connection types capable of allowing communication between the client computing platform 100 and the server computing environment 101.

In one possible embodiment, the server computing environment 101 can be accessed by one or more third party computing systems 112. The third party computing systems 112 provide access to the one or more databases 114 relevant to a multiple-party proceeding. The third party computing systems 112 are preferably utilized by individuals, corporations, or other similar entities who have an interest or role in the proceeding as either a party to the proceeding, an arbitrator, a judge and/or judicial staff, an administrator, or other similar entities.

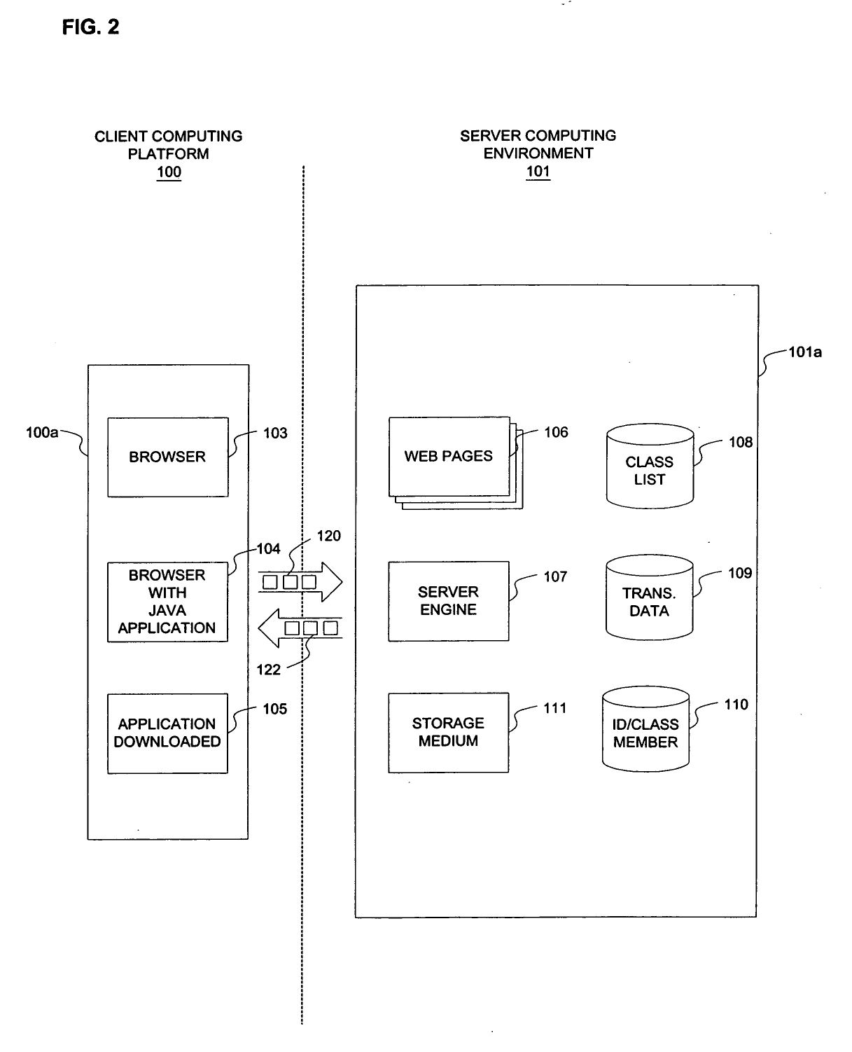

FIG. 2 schematically illustrates the computing environment for assembling a database in a multiple-party proceeding. As discussed above, a claimant may submit one or more claims for relief 120 to the server computing system 101a using the client computing system 100a via the communications network 102 (FIG. 1). Each of the submitted claims for relief 120 can be processed by the server computing system 101a to determine whether the claimant is eligible for relief. For example, each of the submitted claims for relief 120 may be processed to determine whether the claimant is an actual member of the multiple-party proceeding or at least is acting on behalf of an actual member of the proceeding. Valid claims for relief 120 can only be filed by class members or by persons authorized by class members to file claims.

It will be appreciated that each of the claims for relief 120 may be further transmitted from the server computing system 101a. For example, the server computing system 101a may transmit successfully submitted claims for relief 120 to an administrator of the multiple-party proceeding, to parties in the proceeding for further processing, or to third-parties 112 as will be described below in greater detail.

A claimant who files a claim for relief 120 in a multiple-party proceeding using the system of FIG. 2 may be assisted by one or more web pages 106 (e.g., a web site or group of associated web pages interconnected by appropriate hyperlinks) provided from the server computing system 101a. The claimant can access the web pages 106 using, for example, a web browser 103, such as those sold under the brand names Microsoft Internet Explorer™, Netscape Navigator™, or other similar applications. The web browser 103 establishes communication with the web pages 106 over the communications network 102. The web pages 106 contain various information about the class action and information about filing claims in the class action. Specifically, the web pages 106 may include a claim form similar or identical to a claim form that has already been distributed to class members in hardcopy. By filling out and submitting the claim form through the browser 103, the class member can file a claim in the class action more expediently than using conventional methods.

In an alternative to the above example, the class member may use a browser having an online interactive application 104, such as, a Java™ application, as illustrated on the client computing system 100a in FIG. 1. In the illustrated embodiment, the online interactive application 104 may, for example, be downloaded from the server computing system 101a through the communications network 102 (FIG. 1). The online interactive application 104 may allow the claims administrator to particularly configure the claim-filing interface to be suitable for a given multiple-party proceeding.

In yet another alternative to the above example, the class member may use a stand-alone application 105 to communicate with the server computing system 101a. The stand-alone application 105 may be downloaded through the communications network 102 (FIG. 1) using, for example, FTP (File Transfer Protocol) or any other standard file transferring protocol. The stand-alone application 105 may be operated on the client computing system 100a independently of any browser or other application for network communication. The alternative with a stand-alone application 105 may, for example, be used if the class action requires a claim-filing interface that is more suitably operated in a specific application than in a generally available browser.

In connection with the filing of the claim for relief 120, a server engine 107 resident on the server computing system 101a may be used to process the submitted information. The processing may ultimately result in a confirmation message to the claimant that the claim has been successfully filed. As another example, the processing may result in the proposed claim being rejected, because it failed to meet one or more criteria in validity checks that were carried out. Validation of the claims for relief 120 submitted by each of the claimants will be discussed in greater detail below. As yet another example, the server engine 107 may carry out various remedial communications with the claimant, for example allowing the claimant one or more attempts to submit the information necessary for filing the claim.

The server engine 107 may access one or more databases 108-110 to process the submitted claims for relief 120. The databases 108-110 include information pertinent to the multiple-party proceeding and may also be used to store claims for relief 120 that have been filed. The databases 108-110 are stored on one or more computer-readable storage mediums and need not be physically located near the server engine 107.

The computer-readable storage medium 111 contains the software through which the server engine 107 is operating. The storage medium 111 may be the same as the one containing one or more of the tables 108-110. As is commonly known, a computer processor accesses software in order to receive instructions as to which operations are to be carried out. This software may be located on an “internal” medium permanently associated with the computer or on an “external” medium that can be removed from the computer. Software may be stored on many different media, for example magnetic or optical storage media. The medium is capable of encoding a computer program of instructions for executing a computer process for carrying out the operations of the embodiments of the present invention. These operations will be described more specifically below with regard to the examples of methods for assembling databases in multiple-party proceedings in accordance with the present disclosure.

Finally, it should be noted that although the web pages 106, the server engine 107 and the databases 108-110 have been illustrated as residing in the same general computer (e.g., the server computing system 101a). However, one having ordinary skill in the art will readily appreciate that they may be located on different servers in other embodiments. For example, each of the elements 106-110 may reside on an individual machine, which machines are interconnected using conventional technology.

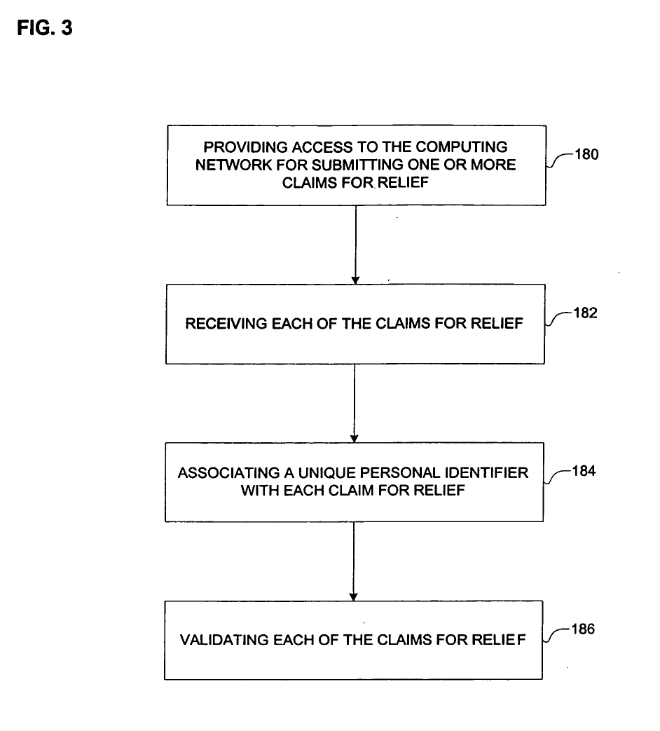

FIG. 3 illustrates a high-level flow chart of the logical operations of the system and method for assembling databases in a multiple-party proceeding in accordance with the present disclosure. Operation 180 provides access to the server computing environment 101 (FIG. 1), thereby, allowing claimants to submit one or more claims for relief 120 (FIG. 1). In particular, each of the claims for relief 120 submitted by the claimants can include first information, such as, claimant identifying information and/or second information, such as, claim processing information. As discussed above, the claimant identifying information generally refers to information that can be used to uniquely identify the claimant, such as, the claimant's name, address, social security number, or other similar identifying information. The claim processing information generally refers to information that can be used to establish the claimant's status within the multiple-party proceeding, such as, eligibility, standing, or other similar information.

At operation 182, each of the claims for relief 120 (FIG. 1) submitted by the claimants are received by the server computing system 101a (FIG. 1) via the communications network 102 (FIG. 1). Operation 184 associates a unique personal identifier with each of the claims for relieve 120. As a result, each of the claims for relief 120 can be uniquely associated with a corresponding claimant within the proceeding using a unique personal identifier, such as, a reference string, keycode, or other similar unique identifier as will be discussed below. A reference string generally includes any sequence of letters, numbers or other characters that is unique for each claimant. Similarly, keycodes generally include a data element that is unique to the claimant but not known to the public, such as, the claimant's social security number, taxpayer identification number, account number(s), serial number(s), or any parts thereof (e.g., the last four digits of the claimant's social security number, etc.). By uniquely associating each claim for relief 120 with a corresponding claimant, fraudulent claims for relief 120 may be easily identified. Furthermore, each of the claims for relief 120 may be conveniently referred to and accessed when necessary.

Operation 186 validates each of the claims for relief 120 submitted by the claimants against a predefined dataset. The phrase “pre-defined dataset” is generally meant to include any information that is known about the claimant or potential claimant that can be used to verify the claimant's identity. For example, the pre-defined dataset can include the list of class members 108, class member unique identifiers 110 (including the reference strings and keycodes as will be discussed in greater detail below).

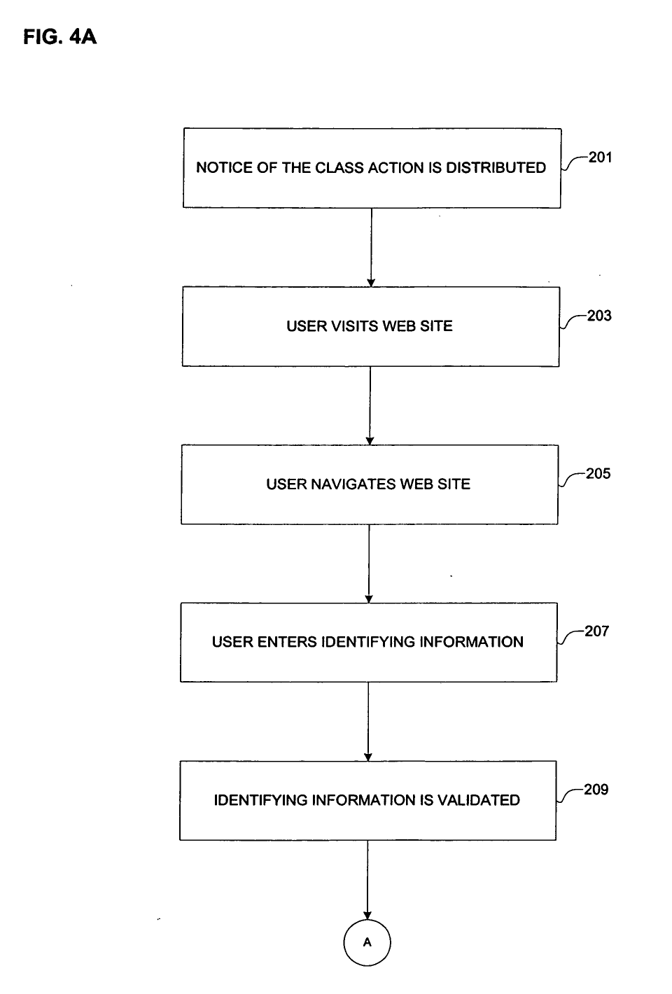

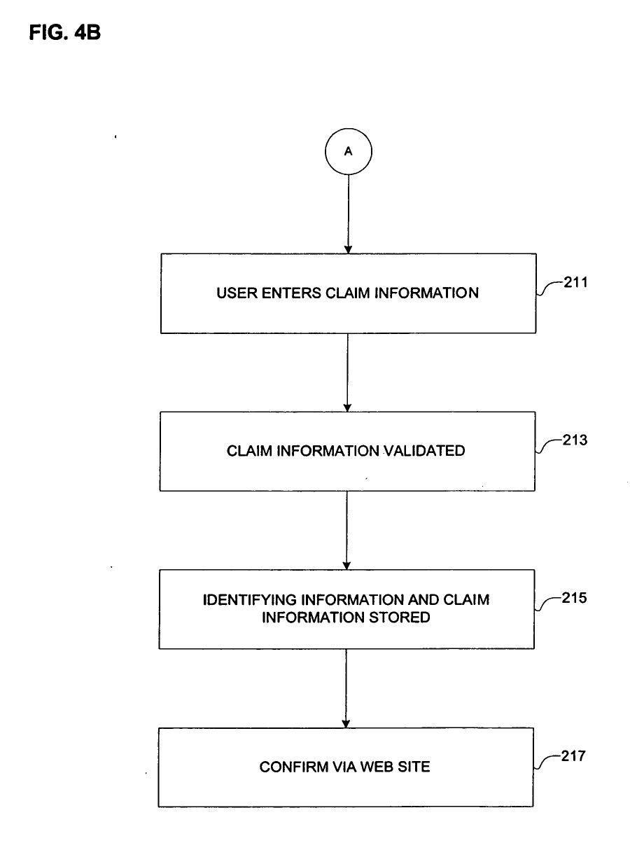

FIGS. 4A-4B illustrate a more detailed flow chart of the logical operations of the system and method for assembling databases in multiple-party proceedings in accordance with the present disclosure. In this example, a class action has been chosen as a practical application in which the method may be used. However, as discussed above, the present disclosure has general applicability to any multiple-party proceeding involving more than one claimant asserting a claim for relief against one or more respondents, such as, a bankruptcy proceeding, a probate or estate dissolution proceeding, or any other similar multiple-party proceeding.

As shown in FIG. 4A, operation 201 involves distributing a common notice of the class action. Typically, this is carried out by mailing the notice to known plaintiffs and publishing the notice to alert any unknown plaintiffs of the class action. Publication of the class notice or a summary notice may take place in different media, such as in newspapers, radio, television and via computer networks such as the Internet. At operation 203, a claimant visits a web site that relates to the class action and which is adapted to allow online filing of claims. This may, for example, be one or more of the web pages 106 (FIG. 2) shown in FIG. 2. The claimant may have been informed about the possibility of online filing through the notice of the class action. As another example, an online class action notice on the Internet may allow the claimant to visit the appropriate web site by clicking on a hyperlink. Operation 205 represents the claimant navigating the web site to the specific location adapted for online claims filing. As described above, this may involve clicking on appropriate hyperlinks as is commonly known.

Upon accessing the web site as discussed above, the claimant can input his/her claim for relief 120 (FIG. 1) into the client computing system 100a (FIG. 1). In particular, at operation 207 the claimant enters claimant identifying information. In one possible embodiment, the web site can contain instructions that inform the claimant what information is needed and how to enter it. Once the claimant provides his/her identifying information, the server computing system 101a can verify the identifying information at operation 209. For example, the server computing system 101a can verify the identifying information by comparing it against tables or lists kept by the claims administrator. For example, the name of the class member may be compared against the table 110 in FIG. 1.

In a particular example of the method, the administrator has provided a reference string to all known plaintiffs in the class action. This reference string may be used to administer claims that have been filed and to protect against fraudulent claims. The reference string may be a sequence of letters, numbers or other characters that is unique for each class member within a given class or multiple-party proceeding. When the claimant submits the reference string, it is verified in operation 209 whether the reference string is valid, i.e. whether it corresponds to one of the reference strings assigned to the known class members. Should the reference string not match the assigned reference strings, the filing process may be terminated immediately. As another example, the claimant may be given a number of chances to properly re-enter the reference string.

As noted above, the class of plaintiffs may change as the class action continues. Some class members that the parties were not aware of may learn about the class action through the public notice and access the web site to file a claim. Such plaintiffs have not yet received reference strings and consequently cannot submit any strings through the web site. Depending on the nature of the claims being asserted in the class action and on the preference of the parties, claimants may or may not be allowed to file claims online without submitting a reference string. If the class action does not allow claims to be filed online without a reference string, the filing process will terminate at this point. The web site may then be adapted to inform the claimant about alternative ways for filing the claim.

Alternatively, the class action may allow claimants to file claims online without first submitting a reference string. For example, filing without the string may be acceptable when it is believed that many class members are unknown to the parties of the action. This may for example be the case when the class action involves consumer claims against a manufacturer for defective products. If there are no complete lists of who has purchased the defective products, the class of plaintiffs is essentially unknown (although the size of the class likely can be estimated through the defendant's sales records.) Allowing claims to be filed without the reference string also may facilitate claim filing where the class member was provided with a reference string but where the claimant has lost the information about the reference string. In an example where claims can be filed online without submitting the reference string, the operation 207 may be completed by submitting other Identifying Information about the person whose claim is being filed. A reference string may be assigned to the submitted information for purposes of administrating the claim.

In another example, the web site will prompt the claimant to submit a string of characters in operation 207. The string will be assigned as the reference string for this particular claim. For example, the web site may instruct the claimant to submit twelve characters to be used as a reference string. As another example, the last name of the class member or a number of letters thereof may be extracted from the submitted information and assigned as the reference string. If the reference string corresponds to information which the claims administrator has access to, the reference string may be validated in operation 209 as described above. Otherwise the validation operation 209 may be omitted.

Moreover, after the claimant has successfully entered his/her identifying information (and completion of any necessary validation), the claimant can input his/her claim processing information. As discussed above, the claim processing information generally refers to information that can be used to establish the claimant's status within the multiple-party proceeding, such as, eligibility, standing, claim value, or other similar information. In particular, the claim processing information can be used to determine if the claimant may be entitled to relief and, if so, the nature of the relief in which the claimant is entitled. For example, in a consumer class action, the claimant may enter the date when the allegedly defective products were purchased, how many products were purchased, the price, where the products were purchased, etc. The nature and amount of the claim processing information to be submitted can vary depending on the parties' preferences and what may have be required by the arbitrator overseeing the proceeding, such as, the judge. In an alternative embodiment, however, the claimant can be required to submit all of the claim processing information in order to file a valid claim for relief 120 (FIG. 1).

Submitting the claim processing information may, for example, involve filling out a claim form on the client computing system 100a (FIG. 1). When the form is complete, it can be submitted through the communications network 102 (FIG. 1) to the server computing system 101a. The claim form typically has fields for submitting the claim for relief 120 (FIG. 1), including the claimant identifying information as well as the claim processing information. Thus, in the above example, the form may have individual fields for the date of purchase, number of items, the purchase price, the name of the store, etc. In a particular example, the class members have received a hardcopy claim form together with the notice of the class action. The class members may use the hardcopy form to acquaint themselves with the information that must be submitted when filing the claim. The class members also may have the option of filing the claim by mailing or faxing the hardcopy form to the claims administrator, in the event the class member cannot or does not want to file the claim online. Preferably, the electronic claim form corresponds to the hardcopy claim form in its contents (i.e. the electronic form contains the same fields) and in its formatting (i.e. the electronic form looks essentially identical to the hardcopy form.) As an example, the form may be provided through an ADOBE ACROBAT™ file or equivalents thereof. When the claimant submits the claim, the form and its contents are transmitted through the communications network 102 for further processing. Once the claimant provides his/her claim processing information, the server computing system 101a can verify the claim processing information at operation 213 to protect against fraudulent claims for relief.

The class action also may require that a keycode be used in the filing of a claim. As discussed above, the keycode is a data element that is unique to the class member and not known to the public. For example, the class member's social security number, taxpayer identification number, account number(s), serial number(s), or parts thereof, may be used as a keycode. Another example is when all the plaintiffs have accounts with corresponding account numbers, in which class action the plaintiffs' account numbers may be used as keycodes. The keycode may be validated in operation 213 as described below provided that the claims administrator has access to the information from which the keycode is formed. Validating the keycode may avoid fraudulent claims filed by a person not authorized by an actual class member. For example, even if a person finds the above-mentioned written notice (which may include a reference string to be submitted), the person cannot file the claim through the web site unless he or she knows the keycode of that particular class member.

In one example, the keycode may comprise a digital signature and/or encryption by the claimant as is commonly understood in the art and as described at http://www.alphatrust.com/products/digital-ID.asp. Digital signatures can be provided by third parties and are for example available from VeriSign (at http://www.verisign.com) or Silanis Technology (at http://www.silanis.com). In one example, the digital signature comprises a code representing a “digital fingerprint” that is unique for the particular document. The digital signature also may contain information about the application of the signature, for example the time, date and place of signature, who made the signature, and how it was made, etc. The digital signature may be embedded in the document at a native binary level in order that it is hidden without affecting the compatibility of the file.

The claimant affixes the digital signature at the end of the form when submitting it, as a means for certifying the content of the claim for relief 120 (FIG. 1) and that the claim was actually submitted by the claimant. When the claim is received, the claims administrator (or anyone else associated with the class action) may use the digital signature to verify the authenticity of the submitted claim.

Operation 211 also may provide that the claim be digitally notarized when it is submitted. Thus, as an example, when the claimant submits his/her claim for relief 120 (FIG. 1) through the network 102, the claim for relief 120 is also sent to a digital notary. Digital notarizing is a means for certifying exactly what information was submitted in the claim and when the claim was filed. The digital notary provides a secure audit trail for the digital records that comprise the claims filed in the class action. This can be carried out by third parties such as Surety™ (at www.surety.com). Through the digital notary, it is later possible to prove exactly what the contents of each claim was and when it was filed. In operation 213, the Claim Information is validated. If a keycode is submitted, it may be validated in this operation. Validating the keycode (e.g. by attempting to match it with the valid keycodes stored in a table), gives protection against fraudulently filed claims, because such claims would not have the correct keycode.

The other Claim Information is validated in operation 213 based on information provided by the parties in the class action. This prevents claimants from filing fraudulent claims, for example by attempting to exaggerate how much of the product they purchased. For example, a consumer class action may involve products purchased during a certain year only. After validation, the claims administrator can dismiss claims in which the claimant bought the product before or after the relevant year. The claimant may be notified about this by immediate feedback through the computer network 102, for example by sending a message to the browser 103 stating that “products purchased during the year XXXX do not qualify for participation in the class action.” As another example, the claimant may not be immediately notified through the computer network; rather, a letter or an email is sent conveying essentially the same information. In a situation where a claimant has purchased products both during qualifying years and non-qualifying years, the validating operation 213 may send a letter or an email stating that the purchases during the non-qualifying years will not qualify for reimbursement in the class action.

In multiple-party proceedings where the claims relate to more narrowly definable series or batches of products, the validation operation 213 will use this information in validating the claimant's claim for relief 120 (FIG. 1). For example, in a products liability class action lawsuit where only products with particular model numbers or serial numbers are involved in the class action, the claimant typically will be required to submit this information as part of the claim for relief, such that the claim can be validated by comparing with the correct model or serial numbers.

In an example where the defendant or defendants are unable to provide exact records of the transactions or sales activities, the validation operation 213 may determine validity based on one or more criteria set by the claims administrator or the parties. For example, in a class action involving defective farm pesticides, the claimant may be required to state how many gallons of the product that were purchased and the size of the farm where it was used. Based on how many gallons reasonably should be used on each acre of farmland, an upper limit of the allowable amount of product can be determined based on the size of the particular farm involved. By comparing the stated amount with the allowable amount for the given acreage, the validation operation 213 determines the validity of the Claim Information. Depending on the nature of the class action and on the preferences of the parties, the validation operation 213 may reject the claim in its entirety once an excessive amount has been detected. As another example, the validation operation 213 may accept the claim up to the maximum reasonable amount as determined above, and notify the claimant that the excessive amount does not qualify for reimbursement in the class action. The reasonable limits on the size of the claim will be set in consideration of the specifics of the particular class action. For example, in a class action involving securities, the claimant may be required to state the price at which the security was purchased. The validation operation 213 then may compare the alleged purchase price with the range of trading prices on the day of the purchase.

Operation 215 stores the claimant's claim for relief 120 (FIG. 1) on the server computing system 101a (FIG. 1). In particular, operation 215 stores the claimant identifying information and claim processing information. The claimant's claim for relief 120 is stored in a way that makes it easily accessible for further use in the multiple-party proceeding. For example, each claim for relief 120 can be uniquely associated with each claimant using a unique personal identifier, such as, a reference string, keycode, or other similar unique identifier as will be discussed below. By uniquely associating each claim for relief 120 with a corresponding claimant, each of the claims for relief 120 may be conveniently referred to and accessed when necessary. The association information (e.g., the unique personal identifier) can be stored in one or more computer-readable storage media 111 (FIG. 2) associated with the server engine 107 (FIG. 2). For example, the claimant identifying information may be stored in the class list database 108 shown in FIG. 2. As another example, the claim processing information may be stored in the transaction data table 109 shown in FIG. 2. The various components on the server computing system 101a in FIG. 1 need not reside on the same computer but can be located on different computers.

The storing operation 215 may be configured to store only claims that are successfully validated at operations 209 and 213. In one possible embodiment, a notice can be provided to the claimants whose claims are not successfully validated and are, therefore, dismissed. As another example, the storing operation 215 may store some or all information submitted as part of a claim for relief 120 (FIG. 1) that ultimately was not permitted to be filed, for example, due to one or more of the validation operations 209 and 213. This is advantageous in that it may allow the claims administrator to determine that the same claimant is making another attempt at filing the same claim. If the previous operations in the method has offered the claimant the opportunity to correct a deficient claim, the storing operation 215 also may store the information submitted in the rejected filing attempts.

Confirmation operation 217 confirms the filed claim to the claimant via the communications network 102 (FIG. 1). This may include displaying a message through the browser 103 (FIG. 2) stating that the claim has been successfully filed, and that each of the claimants will be notified after a decision has been made on whether to grant the claim for relief 120 (FIG. 1) or not.

Each of the claims for relief 120 (FIG. 1) (e.g., the identifying information and claim processing information) gathered from the claimants constitute a database over the filed claims in the class action. As noted earlier, the information may be located in different tables and such tables may or may not reside on the same physical storage medium. Claims for relief (FIG. 1) filed through other means, such as, by letter or fax, may be added to this database by the claims administrator for convenience. In an exemplary proceeding, the claims administrator will recommend to the parties or to the court that the claims in the database be granted. If it is decided to grant the claims in the database, this may be done by sending a distribution check by mail to the class members listed in the database. As an alternative, the distribution may be made electronically through the network 102. This may involve sending a file or equivalent containing the distribution check, which file the claimant can print in order to cash the check as is conventionally known.

As an additional aspect of the above embodiments, third-parties may access the database assembled by the system and method of the present disclosure. For example, the parties (e.g., the claimants and the respondents) of the multiple-party proceeding may be given access to the server computing system 101a as discussed above. This may for example be provided such that the parties can access the database(s) 114 (FIG. 1) through the computer network 102. In this example, the respondent may access the database 114 by entering a suitable password or equivalent in order to review the filed claims. The access may be provided through the web site where claims are being filed or through a different web site. This access allows the parties a convenient way of monitoring the continuous filing of claims and receiving up-to-date information on the progress of the claims administration. For example, it may allow the parties to examine individual claims and/or the submitted documentation.

Other arrangements also are possible, for example one in which the parties may access the database through a second computer network. Another example is that the information is stored on a storage medium belonging to the defendant. In the latter example, the storing operation 215 may store one or more of the claims for relief 120 (FIG. 1) directly on the respondent's computer.

While the invention has been particularly shown and described with reference to embodiments thereof, it will be understood by those skilled in the art that various other changes in the form and details may be made therein without departing from the spirit and scope of the invention.

The claimed invention is:

1. A method for assembling a database regarding claimant eligibility for relief in a multiple-party proceeding, the method comprising:
providing access via a computer network for filing one or more claims for relief in the multiple-party proceeding, each of the claims for relief comprising first information regarding a potential claimant and second information regarding the potential claimant's eligibility for relief;
receiving each of the claims for relief via the computer network; and
validating each of the claims for relief by comparing either of the first or second information against a predefined dataset.

2. The method according to claim 1, wherein the pre-defined dataset includes a class list of known class members potentially eligible for relief.

3. The method according to claim 1, the method further comprising associating a unique personal identifier with each of the claims for relief, the unique personal identifier being capable of uniquely identifying the potential claimant.

4. The method according to claim 3, wherein associating a unique personal identifier with each of the claims for relief includes associating a reference string with each of the claims for relief.

5. The method according to claim 4, the method further comprising:
providing the reference string to the potential claimant prior to receiving each of the claims for relief; and
receiving the reference string with each of the claims for relief.

6. The method according to claim 5, wherein validating each of the claims for relief comprises comparing the reference string provided to the potential claimant against the reference string received with each of the claims for relief.

7. The method according to claim 3, wherein associating a unique personal identifier with each of the claims for relief includes associating a keycode with each of the claims for relief.

8. The method according to claim 7, the method further comprising receiving the keycode with each of the claims for relief.

9. The method according to claim 8, wherein validating each of the claims for relief comprises comparing the keycode received with each of the claims for relief against the pre-defined dataset.

10. The method according to claim 8, further comprising processing the keycode to determine whether the potential claimant may be eligible for relief.

11. The method according to claims 5 and 8, wherein validating each of the claims for relief comprises:
comparing the reference string provided to the potential claimant against the reference string received with each of the claims for relief; and
comparing the keycode received with each of the claims for relief against the predefined dataset.

12. The method according to claim 1, wherein providing access comprises transmitting a computer application via the computer network, the computer application being configured to receive each of the claims for relief.

13. The method according to claim 1, wherein providing access comprises providing a form via the computer network, the form being adapted for receiving each of the claims for relief.

14. The method according to claim 1, further comprising processing at least one of the first and second information to determine whether the potential claimant may be eligible for relief.

15. The method according to claim 14, wherein processing at least one of the first and second information comprises defining a criterion for eligibility for relief and determining whether at least part of the second information meets the criterion.

16. The method according to claim 1, further comprising storing third information associated with receiving each of the claims for relief.

17. The method according to claim 16, wherein storing the third information comprises storing one selected from the group consisting of a network address from which each of the claims for relief was received, a date when the each of the claims for relief was received, and a time when each of the claims for relief was received.

18. The method according to claim 1, the method further comprising receiving a digital signature uniquely identifying the source of each of the claims for relief.

19. The method according to claim 1, the method further comprising confirming receipt of the first and second information via the computer network.

20. The method according to claim 1, the method further comprising providing a distribution to eligible claimants in the multiple-party proceeding.

21. The method according to claim 1, the method further comprising providing access to the database to at least one party in the multiple-party proceeding thereby allowing the at least one party in the multiple-party proceeding to monitor the filing of each of the claims for relief.

22. A computer system for assembling a database regarding claimant eligibility for relief in a multiple-party proceeding, the system comprising:
a client computing system for providing access via a computer network for filing one or more claims for relief in the multiple-party proceeding, each of the claims for relief comprising first information regarding a potential claimant and second information regarding the potential claimant's eligibility for relief; and
a server computing system for receiving each of the claims for relief via the computer network; and
a validation module for validating each of the claims for relief by comparing either of the first or second information against a pre-defined dataset.

23. The system according to claim 22, wherein the pre-defined dataset includes a class list of known class members potentially eligible for relief.

24. The system according to claim 22, further comprising a reference string that has been provided to potential claimants prior to receiving the first and second information, wherein the reference string is received in connection with the first and second information, and wherein the validation module processes the reference string to determine whether the potential claimant may be eligible for relief.

25. The system according to claim 22, further comprising a keycode received in connection with the first and second information, and wherein the validation module processes the keycode to determine whether the potential claimant may be eligible for relief.

26. The system according to claim 22, wherein the validation module processes at least one of the first and second information to determine whether the potential claimant may be eligible for relief.
